(19) United States
(12) Patent Application Publication
(10) Pub. No.: US 2013/0305146 A1
(43) Pub. Date: Nov. 14, 2013

(54) SYSTEM AND HANDWRITTEN DOCUMENT MANAGEMENT METHOD

(71) Applicants: Rumiko Hashiba, Kawasaki-shi (JP); Hideki Tsutsui, Tachikawa-shi (JP); Sachie Yokoyama, Ome-shi (JP); Toshihiro Fujibayashi, Hino-shi (JP); Chikashi Sugiura, Hamura-shi (JP); Takehiko Isaka, Hachioji-shi (JP); Takashi Sudo, Fuchu-shi (JP)

(72) Inventors: Rumiko Hashiba, Kawasaki-shi (JP); Hideki Tsutsui, Tachikawa-shi (JP); Sachie Yokoyama, Ome-shi (JP); Toshihiro Fujibayashi, Hino-shi (JP); Chikashi Sugiura, Hamura-shi (JP); Takehiko Isaka, Hachioji-shi (JP); Takashi Sudo, Fuchu-shi (JP)

(73) Assignee: KABUSHIKI KAISHA TOSHIBA, Tokyo (JP)

(21) Appl. No.: 13/601,081

(22) Filed: Aug. 31, 2012

(30) Foreign Application Priority Data
May 11, 2012 (JP) 2012-109829

(51) Int. Cl. G06F 17/20

(52) U.S. Cl. 715/255

(57) ABSTRACT

According to one embodiment, a system includes a receiver, a storage, a retrieval module and a transmitter. The receiver receives handwritten document data, which includes stroke data corresponding to strokes, from a first electronic device. The storage stores a handwritten document data in addition to a plurality of document data. The retrieval module retrieves, in response to a request by a second electronic device, first handwritten document data corresponding to the request from the plurality of document data in the storage. The transmitter transmit the first handwritten document data to the second electronic device.

### CROSS-REFERENCE TO RELATED APPLICATIONS

This application is based upon and claims the benefit of priority from Japanese Patent Application No. 2012-109829, filed May 11, 2012, the entire contents of which are incorporated herein by reference.

### FIELD

Embodiments described herein relate generally to a system which manages a handwritten document, and a handwritten document management method applied to the system.

### BACKGROUND

In recent years, various kinds of electronic devices, such as a tablet, a PDA and a smartphone, have been developed. Most of these electronic devices include touch-screen displays for facilitating input operations by users. By touching a menu or an object, which is displayed on the touch-screen display, by a finger or the like, the user can instruct the electronic device to execute a function associated with the menu or object.

However, most of existing electronic devices with touch-screen displays are consumer products which are designed to enhance operability on various media data such as video and music, and are not necessarily suitable for use in a business situation such as a meeting, a business negotiation or product development. Thus, in a business situation, sentences, graphics, tables, etc., which summarize the descriptions of discussions, are handwritten on paper sheets or whiteboards, from the standpoint of ease and free-form expression, thereby sharing recognition among participants. In some cases, such handwritten information is digitized in order that the handwritten information may be stored as evidence of the meeting or may be made known to related persons. In addition, there has been an increasing demand for digitizing and storing personal memoranda such as handwritten memoranda of participants.

A document, which is handwritten on paper or a whiteboard, can be converted to image data, for example, by using a scanner or a camera.

Participants of a meeting or the like browse image data corresponding to a handwritten document by using electronic devices which are used by the respective participants. However, the electronic devices used by the participants are assumed to be various kinds of electronic devices such as tablets, PDAs and smartphones, as described above. Thus, in some cases, each electronic device is expected to enable browsing of electronic data suitable for the function possessed by the electronic device. Besides, in business situations, there are cases that it is expected to provide not only image data corresponding to a handwritten document, but also data which may support a person's thinking activities or may make easier the re-use of materials such as documents which were prepared in the past.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram illustrating a configuration of a cloud service system.

FIG. 2 is an exemplary perspective view illustrating an external appearance of the first electronic device.

FIG. 3 is an exemplary view illustrating an example of a handwritten document.

FIG. 4 is an exemplary view for explaining handwritten document data.

FIG. 5 is an exemplary block diagram illustrating a functional configuration of a handwritten document management program of an embodiment.

FIG. 6 shows a configuration example of user data which is used by the system of the embodiment.

FIG. 7 shows a configuration example of access right data of the embodiment.

FIG. 8 shows an example of presentation material data of the embodiment.

FIG. 9 is an exemplary block diagram illustrating an example of a system configuration of the system of the embodiment.

FIG. 10 is an exemplary block diagram illustrating an example of a system configuration of the first electronic device (handwriting terminal) of FIG. 1.

FIG. 11 is an exemplary block diagram illustrating an example of a system configuration of the second electronic device (browsing terminal) of FIG. 1.

FIG. 12 is an exemplary flowchart illustrating an example of the procedure of an upload process.

FIG. 13 is an exemplary flowchart illustrating an example of the procedure of a handwritten document data reception process.

FIG. 14 is an exemplary flowchart illustrating an example of the procedure of a download process.

FIG. 15 is an exemplary flowchart illustrating an example of the procedure of a handwritten document data transmission process.

### DETAILED DESCRIPTION

Various embodiments will be described hereinafter with reference to the accompanying drawings.

In general, according to one embodiment, a system, which is connectable to a plurality of electronic devices via a network, includes a receiver, a storage, a retrieval module, and a transmitter. The receiver is configured to receive handwritten document data from a first electronic device, wherein the handwritten document data includes a plurality of stroke data corresponding to a plurality of strokes. The storage is configured to store a received handwritten document data in addition to a plurality of handwritten document data. The retrieval module is configured to retrieve, in response to a request by a second electronic device, first handwritten document data from the plurality of handwritten document data in the storage, the first handwritten document data corresponding to the request. The transmitter is configured to transmit the first handwritten document data to the second electronic device.

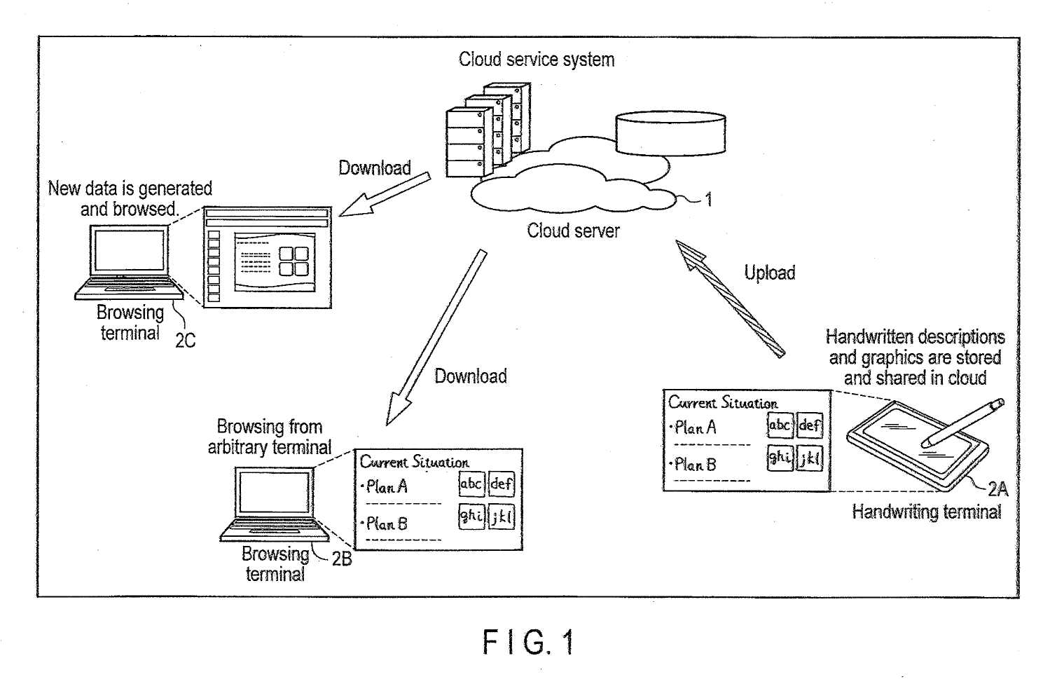

To begin with, referring to FIG. 1, a description is given of a cloud service system including a system according to an embodiment, and electronic devices which cooperate with the system. The system may be realized, for example, as a server computer (hereinafter also referred to as “cloud server”) 1. The cloud server 1 executes an online storage service, and other various cloud computing services. The cloud server 1 can cooperate with various electronic devices such as a handwriting terminal (first electronic device) 2A and a browsing terminal (second electronic device) 2B, 2C.

The handwriting terminal 2A is, for instance, a pen-based portable electronic device which can execute a handwriting input by a pen or a finger. The handwriting terminal 2A may be realized as a tablet computer, a notebook-type personal computer, a smartphone, a PDA, etc. In addition, the browsing terminal 2B, 2C is an electronic device for browsing a handwritten document which is created by a handwriting input with use of the handwriting terminal 2A. The browsing terminal 2B, 2C may be realized as a tablet computer, a notebook-type personal computer, a desktop-type computer, a smartphone, a PDA, etc.

The cloud server 1 includes a communication device of, for example, a local area network (LAN). In addition, the handwriting terminal 2A and browsing terminal 2B, 2C include wireless communication devices of, for example, a wireless LAN. Accordingly, the cloud server 1 can communicate with the handwriting terminal 2A and browsing terminals 2B and 2C.

The handwriting terminal 2A transmits data of a handwritten document including characters (text) and graphics, which has been created by a handwriting input operation by a user, to the cloud server 1 via a network (e.g. Internet), and stores this data in a storage (e.g. a hard disk drive (HDD)) in the cloud server 1 (“upload”). In order to ensure a secure communication between the cloud server 1 and handwriting terminal 2A, the cloud server 1 may authenticate the handwriting terminal 2A at a time of starting the communication. In this case, a dialog for prompting the user to input an ID and/or a password may be displayed on the screen of the handwriting terminal 2A. Alternately, the ID of the handwriting terminal 2A, for example, may be automatically transmitted from handwriting terminal 2A to the cloud server 1.

Thereby, the handwritten document data, which has been generated on the handwriting terminal 2A, can be managed in the cloud server 1.

The cloud server 1 transmits handwritten document data, which is stored in the storage of the cloud server 1, to the browsing terminal 2B via the network (e.g. Internet). For example, the cloud server 1 converts the handwritten document data, which was uploaded by the handwriting terminal 2A and is stored in the storage of the cloud server 1, into a format which can be browsed by the browsing terminal 2B, and transmits the converted handwritten document data to the browsing terminal 2B. The browsing terminal 2B receives the handwritten document data transmitted from the cloud server 1 (“download”), and can display a handwritten document based on the received handwritten document data on the screen of the display of the browsing terminal 2B.

The cloud server 1 can also generate new data by using handwritten document data stored in the storage of the cloud server 1, and can transmit the generated new data to the browsing terminal 2C. For example, using the handwritten document data which was uploaded from the handwriting terminal 2A and is stored in the storage of the cloud server 1, the cloud server 1 recognizes characters (text) and graphics described on the handwritten document of the handwritten document data, converts the handwritten document data to a format of, e.g. word-processing software, presentation software or a conception supporting tool (e.g. a conception supporting tool based on a KJ method or a mind map), and transmits the generated data to the browsing terminal 2C. The browsing terminal 2C receives the data that has been newly generated by the cloud server 1 (“download”), and can display information based on the newly generated data on the screen of the display of the browsing terminal 2C.

In order to ensure a secure communication between the cloud server 1 and browsing terminal 2B, 2C, the cloud server 1 may authenticate the browsing terminal 2B, 2C at a time of starting the communication. In this case, a dialog for prompting the user to input an ID and/or a password may be displayed on the screen of the browsing terminal 2B, 2C. Alternately, the ID of the browsing terminal 2B, 2C may be automatically transmitted from the browsing terminal 2B, 2C to the cloud server 1. Incidentally, the handwriting terminal 2A can also be used as the browsing terminal 2B, 2C.

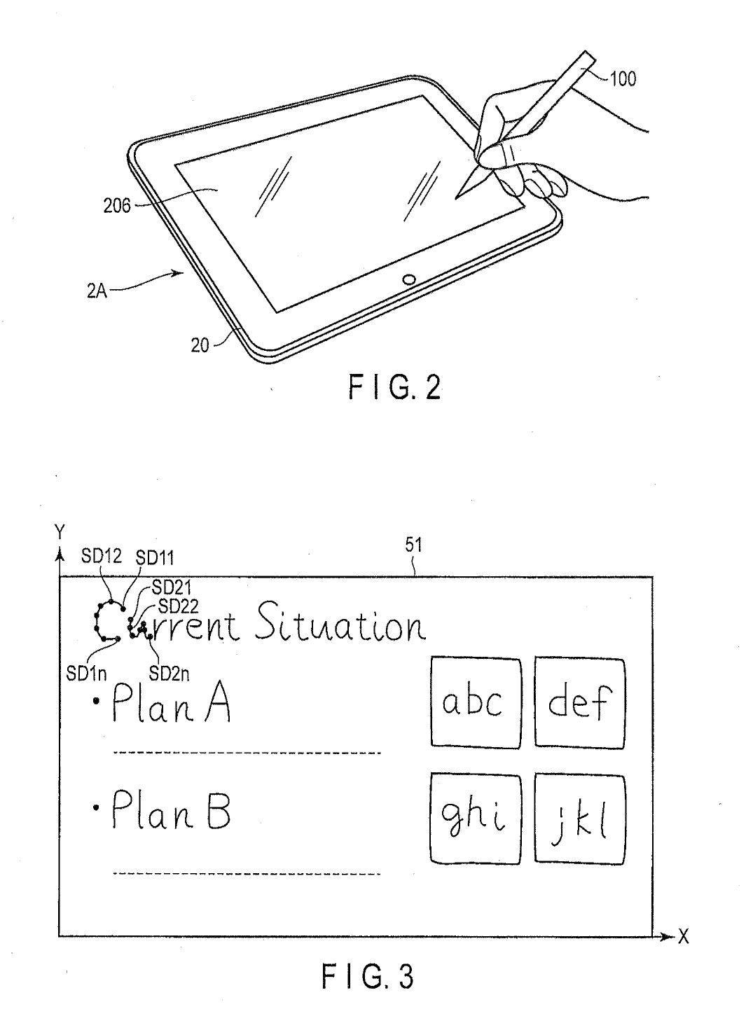

FIG. 2 is an exemplary perspective view illustrating an external appearance of the handwriting terminal 2A. In the description below, it is assumed that the handwriting terminal 2A is realized as a tablet computer. The tablet computer 2A is a portable electronic device which is also called “tablet” or “slate computer”. As shown in FIG. 2, the tablet computer 2A includes a main body 20 and a touch-screen display 206. The touch-screen display 206 is attached such that the touch-screen display 206 is laid over the top surface of the main body 20.

The main body 20 has a thin box-shaped housing. A flat-panel display and a sensor are built into the touch-screen display 206. The sensor is configured to detect a touch position of a pen or a finger on the screen of the flat-panel display. The flat-panel display may be, for instance, a liquid crystal display (LCD). As the sensor, for example, use may be made of a capacitance-type touch panel, or an electromagnetic induction-type digitizer. In the description below, it is assumed that two kinds of sensors, namely a digitizer and a touch panel, are both built in the touch-screen display 206.

Each of the digitizer and the touch panel is provided in a manner to cover the screen of the flat-panel display. The touch-screen display 206 detects not only a touch operation on the screen with use of a finger, but also a touch operation on the screen with use of a pen 100. The pen 100 may be, for instance, an electromagnetic-induction pen. The user can perform a handwriting input operation on the touch-screen display 206 by using an external object (pen 100 or finger). During the handwriting input operation, a path of movement of the external object (pen 100 or finger) on the screen, that is, a path (a trace of writing) of a stroke that is handwritten by the handwriting input operation, is drawn in real time, and thereby the path of each stroke is displayed on the screen. A path of movement of the external object during a time in which the external object is in contact with the screen corresponds to one stroke. A set of many strokes corresponding to handwritten characters or graphics, that is, a set of many paths (traces of writing), constitutes a handwritten document.

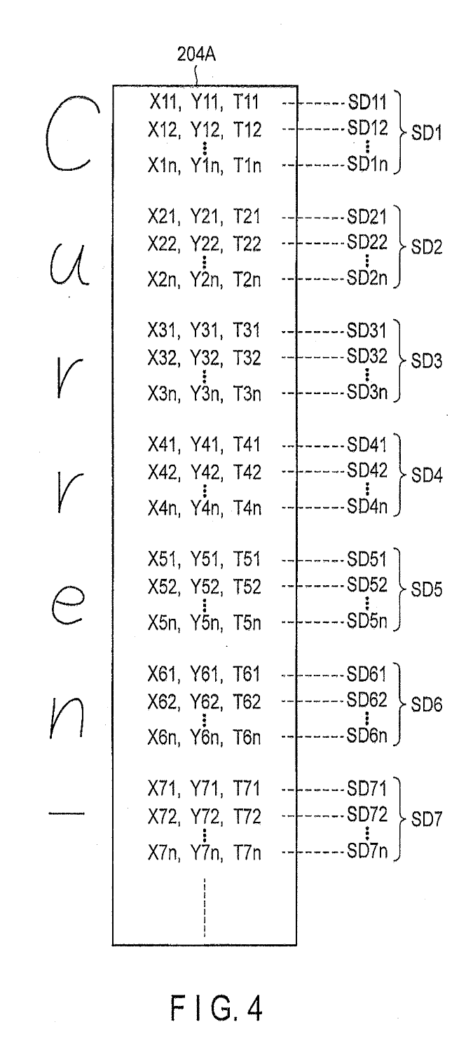

In the present embodiment, this handwritten document is stored, for example, in a storage medium in the handwriting terminal 2A, not as image data but as handwritten document data which includes coordinate series of the paths of strokes and time-series information indicative of the order relation between the strokes. The details of this time-series information will be described later with reference to FIG. 4. In general terms, this time-series information means a set of time-series stroke data corresponding to a plurality of strokes. Each stroke data corresponds to one stroke, and includes coordinate data series (time-series coordinates) corresponding to points on the path of this stroke. The order of arrangement of these stroke data corresponds to an order in which strokes are handwritten, that is, an order of strokes.

The handwriting terminal 2A can read arbitrary existing time-series information (handwritten document data) from the storage medium, and can display on the screen a handwritten document corresponding to this time-series information, that is, the paths corresponding to a plurality of strokes indicated by this time-series information. Furthermore, the handwriting terminal 2A has an edit function. By the edit function, the handwriting terminal 2A can delete or move an arbitrary stroke or an arbitrary handwritten character or the like in the displayed handwritten document, in accordance with an edit operation by the user with use of an “eraser” tool, an area select tool, and other various tools. In addition, this edit function includes an undo facility for some handwriting operations in the history.

In this embodiment, the time-series information (handwritten document data) may be managed as one page or plural pages. In this case, the time-series information (handwritten document data) may be divided in units of an area which falls within one screen, and thereby a piece of time-series information, which falls within one screen, may be recorded as one page. Alternatively, the size of one page may be made variable. In this case, since the size of a page can be increased to an area which is larger than the size of one screen, a handwritten document of an area larger than the size of the screen can be handled as one page. When one whole page cannot be displayed on the display at a time, this page may be scaled down, or a display target part in the page may be moved by vertical and horizontal scrolling.

Next, referring to FIGS. 3 and 4, a description is given of a relationship between strokes (characters, marks, graphics, tables, etc.), which are handwritten by the user, and time-series information. FIG. 3 shows an example of a handwritten document (handwritten character strings and graphics) 51 which is handwritten on the touch-screen display 206 by using the pen 100 or the like.

In many cases, on the handwritten document 51, other characters or graphics are handwritten over already handwritten characters or graphics. In FIG. 3, for example, it is assumed that a handwritten character string “Current” was handwritten in the order of “C”, “u”, “r”, “r”, “e”, “n” and “t”.

The handwritten character “C” is expressed by one stroke which is handwritten by using the pen 100 or the like, that is, by one path: A path of the pen 100, which corresponds to the first handwritten “C”, is sampled in real time, for example, at regular time intervals, and thereby time-series coordinates SD11, SD12, . . . , SD1n of the stroke corresponding to “C” are obtained. The handwritten character “u” is expressed by one stroke which is handwritten by using the pen 100 or the like, that is, by one path. Similarly, a path of the pen 100, which corresponds to the next handwritten “u” shape, is sampled, and thereby time-series coordinates SD21, SD22, . . . , SD2n of the stroke of the “u” shape are obtained. In addition, the handwritten character “t” is expressed by two strokes which are handwritten by using the pen 100 or the like, that is, by two paths.

FIG. 4 illustrates handwritten document data 204A including time-series information corresponding to the handwritten document 51 of FIG. 3. The time-series information includes a plurality of stroke data SD1, SD2, . . . , SD7. An order of handwriting of the plurality of stroke data is identifiable in the handwritten document data 204A. In the handwritten document data 204A, for example, the stroke data SD1, SD2, . . . , SD7 are arranged in time series in the order of strokes, that is, in the order in which plural strokes are handwritten.

In the handwritten document data 204A, the first stroke data SD1 is indicative of the stroke of handwritten character “C”. The second stroke data SD2 is indicative of the stroke which constitutes handwritten character “u”. The third stroke data SD3 is indicative of one stroke which constitutes handwritten character “r”. The fourth stroke data SD4 is indicative of one stroke which constitutes handwritten character “r”. The fifth stroke data SD5 is indicative of one stroke which constitutes handwritten character “e”. The sixth stroke data SD6 is indicative of one stroke which constitutes handwritten character “n”. The seventh stroke data SD7 is indicative of one stroke which constitutes “-” in handwritten character “t”.

Each stroke data includes coordinate data series (time-series coordinates) corresponding to one stroke, that is, a plurality of coordinates corresponding to a plurality of points on the path of one stroke. In each stroke data, the plural coordinates are arranged in time series in the order in which the stroke is written. For example, as regards handwritten character “C”, the stroke data SD1 includes coordinate data series (time-series coordinates) corresponding to the points on the path of the stroke of the handwritten character “C” shape, that is, an n-number of coordinate data SD11, SD12, . . . , SD1n. The stroke data SD2 includes coordinate data series corresponding to the points on the path of the stroke of the handwritten character “u” shape, that is, an n-number of coordinate data SD21, SD22, . . . , SD2n. Incidentally, the number n of coordinate data may differ between respective stroke data.

Each coordinate data is indicative of an X coordinate and a Y coordinate, which correspond to one point in the associated path. For example, the coordinate data SD11 is indicative of an X coordinate (X11) and a Y coordinate (Y11) of the starting point of the stroke of the “C” shape. The coordinate data SD1n is indicative of an X coordinate (X1n) and a Y coordinate (Y1n) of the end point of the stroke of the “C” shape.

Further, each coordinate data may include time stamp information T corresponding to a time point at which a point corresponding to this coordinate data was handwritten. The time point at which the point was handwritten may be either an absolute time (e.g. year/month/date/hour/minute/second) or a relative time with reference to a certain time point. For example, an absolute time (e.g. year/month/date/hour/minute/second) at which a stroke began to be handwritten may be added as time stamp information to each stroke data, and furthermore a relative time indicative of a difference from the absolute time may be added as time stamp information T to each coordinate data in the stroke data.

In this manner, by using the time-series information in which the time stamp information T is added to each coordinate data, the temporal relationship between strokes can be precisely expressed. Moreover, information (Z) indicative of a pen stroke pressure may be added to each coordinate data.

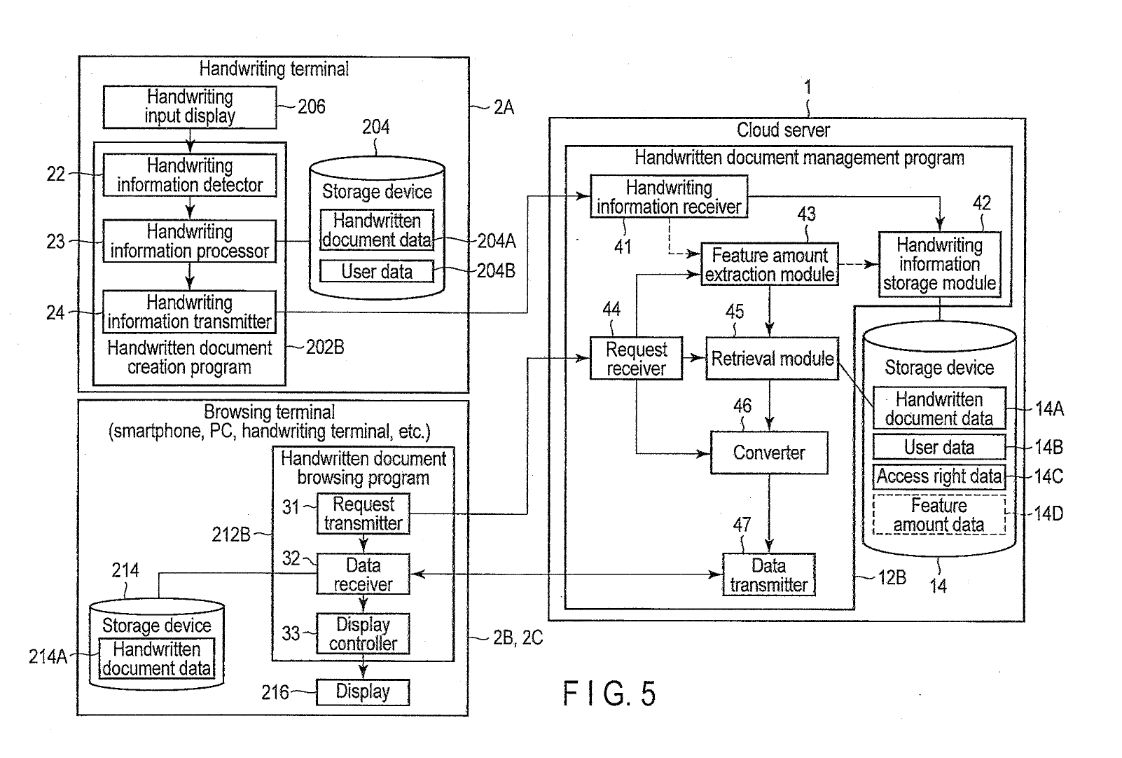

Next, referring to FIG. 5, a description is given of a functional structure of the cloud server 1, and functional structures of the handwriting terminal 2A and browsing terminal 2B, 2C, which cooperate with the cloud server 1.

To begin with, the handwriting terminal 2A is described.

The handwriting terminal 2A executes a handwritten document creation program 202B for generating handwritten document data 204A in accordance with a handwriting input with use of a handwriting input display (touch-screen display) 206, and uploading the generated handwritten document data 204A to the cloud server 1. The handwritten document creation program 202B includes a handwriting information detector 22, a handwriting information processor 23 and a handwriting information transmitter 24.

The handwriting information detector 22 detects a path of movement of an external object (pen 100 or finger) on the screen of the handwriting input display 206. The handwriting information detector 22 generates stroke data indicative of coordinate data series (time-series coordinates) corresponding to points on the detected path. The handwriting information detector 22 outputs the generated stroke data to the handwriting information processor 23. In the meantime, when a document created by word-processing software or a slide created by presentation software is being displayed on the screen of the handwriting input display 206, the handwriting information detector 22 can also detect a path of movement of the external object on this screen and can generate stroke data.

The handwriting information processor 23 stores the stroke data, which has been output from the handwriting information detector 22, in a storage device 204. The handwriting information processor 23 may put together plural stroke data under a predetermined condition, and may store the plural stroke data as handwritten document data 204A in the storage device 204. Specifically, the handwriting information processor 23 collectively stores, for example, one or more stroke data in units of a “block” of a character or a graphic. In addition, the handwriting information processor 23 collectively stores, for example, one or more stroke data in units of a “page” of a predetermined area (e.g. screen size). When the stroke data are collectively stored based on a predetermined condition, the handwriting information processor 23 generates handwritten document data 204A in which information of “block” or “page” is added to the stroke data, and stores the handwritten document data 204A in the storage device 204. The handwriting information processor 23 can also store the handwritten document data 204A by adding thereto a relation between blocks or pages. For example, the handwriting information processor 23 stores handwritten document data 204A corresponding to a certain block (or stroke, page) and handwritten document data 204A corresponding to another block (or stroke, page) by mutually associating them. In addition, the handwriting information processor 23 can store handwritten document data 204A based on an input operation on the screen displaying a document created by word-processing software or a slide created by presentation software, by associating the handwritten document data 204A with this document (document file) or slide (slide presentation file).

Besides, the handwriting information processor 23 may generate access right data (an entry of access right data) for setting an access right at a time when the generated handwritten document data 204A has been uploaded to the cloud server 1. For example, in accordance with an instruction by the user, the handwriting information processor 23 generates access right data for the handwritten document data 204A. This access right data is indicative of, for example, the range of users (or computers) which are permitted to browse, the range of data (range of blocks, pages, or strokes) which are permitted to be browsed, and the period (publication period) during which browsing is permitted.

The handwriting information processor 23 outputs the generated handwritten document data 204A (or stroke data) and access right data, as well as user data 204B (an entry of user data) that is stored in the storage device 204, to the handwriting information transmitter 24. The user data 204B includes information (e.g. user name, user ID) relating to the user who created the handwritten document, and a keyword (tag) relating to the handwritten document. The user data 204B may be input by the user at a time of a handwriting input operation.

The handwriting information transmitter 24 transmits the handwritten document data 204A, access right data and user data 204B, which have been output from the handwriting information processor 23, to the cloud server 1 by using a wireless communication device or the like (“upload”).

Next, the cloud server 1 is described. The cloud server 1 executes a handwritten document management program 12B for managing handwritten document data 14A which has been uploaded from the handwriting terminal 2A. The handwritten document management program 12B includes a handwriting information receiver 41, a handwriting information storage module 42, a feature amount extraction module 43, a request receiver 44, a retrieval module 45, a converter 46, and a data transmitter 47. The cloud server 1, as described above, includes a function of storing in the storage the handwritten document data which has been transmitted from the handwriting terminal 2A, and a function of delivering the stored handwritten document data to the browsing terminal 2B, 2C.

To begin with, a description is given of the function of storing in the storage the handwritten document data which has been transmitted from the handwriting terminal 2A.

The handwriting information receiver 41 receives the handwritten document data 204A, access right data and user data 204B, which have been transmitted from the handwriting terminal 2A (handwriting information transmitter 24) by using a communication device or the like. The handwriting information receiver 41 outputs the received handwritten document data 204A, access right data and user data 204B to the handwriting information storage module 42.

The handwriting information storage module 42 stores in a storage device 14 the handwritten document data 204A, access right data and user data 204B, which have been output from the handwriting information receiver 41. To be more specific, the handwriting information storage module 42 adds an entry of the user data 204B, which has been output from the handwriting information receiver 41, to user data 14B in the storage device 14. In addition, the handwriting information storage module 42 adds an entry of the access right data, which has been output from the handwriting information receiver 41, to access right data 14C in the storage device 14. In the meantime, when access right data corresponding to the handwritten document data 204A has not been transmitted from the handwriting terminal 2A, the handwriting information storage module 42 may generate an entry of access right data for setting an access right to the handwritten document data 204A and may add the entry to the access right data 14C in the storage device 14. In addition, the storage device 14 may be provided in the cloud server 1, or may be provided in another computer, such as a file server, which cooperates with the cloud server 1.

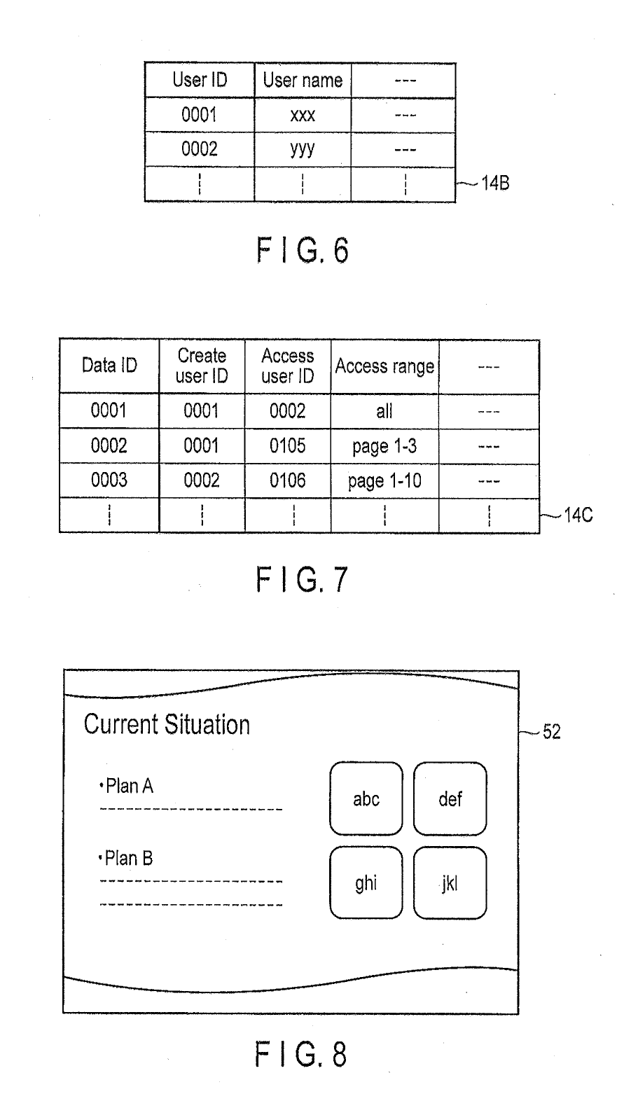

FIG. 6 shows a configuration example of the user data 14B which is used by the cloud server 1. The user data 14B includes a plurality of entries corresponding to a plurality of users, who access the cloud server 1 by using the handwriting terminal 2A or browsing terminal 2B, 2C. Each entry includes, for example, a user ID and a user name. In an entry corresponding to a certain user, “User ID” is indicative of identification information which is given to the user. “User name” is indicative of the name of the user.

In addition, FIG. 7 shows a configuration example of the access right data 14C which is used by the cloud server 1. The access right data 14C includes, for example, a plurality of entries corresponding to a plurality of access right settings for the handwritten document data 14A. Each entry includes, for example, a data ID, a create user ID, an access user ID, and an access range. In an entry corresponding to the access right setting for certain handwritten document data 14A, “Data ID” is indicative of identification information which is given to this handwritten document data 14A. “Create user ID” is indicative of a user ID of a user (account) who created the handwritten document data 14A. “Access user ID” is indicative of a user ID of a user (account) who is permitted to access this handwritten document data 14A. “Access range” is indicative of a range of that data, among the handwritten document data 14A, which is permitted to be accessed by the user having the user ID of the “Access user ID”. In the “Access range”, for example, such setting is made that the entirety of the handwritten document data 14A is accessible (“all”), that predetermined pages (“page 1-3”) in the handwritten document data 14A are accessible, or that predetermined blocks (“block 1-10”) in the handwritten document data 14A are accessible. With the access range being set in this manner, for example, handwritten documents, which appear in different ways, can be provided to the respective users (access users). Incidentally, the entry of the access right data 14C may include a period in which the handwritten document data 14A is made available.

By using the above-described user data 14B and access right data 14C, the handwriting information storage module 42 stores the handwritten document data 14A in association with the information relating to the user who created the handwritten document data 14A, and the information relating to the access right to the handwritten document data 14A.

In the meantime, the handwriting information receiver 41 may output the handwritten document data 204A, which has been received from the handwriting terminal 2A, to the feature amount extraction module 43. The feature amount extraction module 43 calculates a feature amount by using the stroke data in the handwritten document data 204A. The feature amount extraction module 43 calculates a feature amount relating to coordinates or time, for example, by using the time-series coordinate data sequence of the stroke data. The feature amount extraction module 43 may convert handwritten characters in the handwritten document to character codes, or may convert a handwritten graphic to a predetermined graphic object, by analyzing the handwritten document data 204A. The feature amount extraction module 43 stores the calculated feature amount as feature amount data 14D in the storage device 14.

Next, a description is given of the function in the cloud server 1 of delivering the stored handwritten document data to the browsing terminal 2B, 2C.

To begin with, the request receiver 44 receives a delivery request for handwritten document data from the browsing terminal 2B, 2C (request transmitter 31). The delivery request includes, for example, terminal information relating to the browsing terminal 2B, 2C, user information relating to a user who uses the browsing terminal 2B, 2C, and a search key for searching handwritten document data 14A. The terminal information includes, for example, identification information (terminal ID) of the browsing terminal 2B, 2C, information indicative of the model of the browsing terminal 2B, 2C, information indicative of an OS executed on the browsing terminal 2B, 2C, information indicating whether or not the browsing terminal 2B, 2C has a function of analyzing handwritten document data (stroke data) and displaying a handwritten document (hereinafter also referred to as “handwritten document display function”), and information indicative of the screen size of the browsing terminal 2B, 2C. The user information includes a user ID and a user name. The search key includes, for example, stroke data. Specifically, the request receiver 44 receives stroke data corresponding to a handwritten character string or a handwritten graphic, as a search key for searching the handwritten document data 14A in the storage device 14. The delivery request may further include format information indicative of the format of data which is to be delivered from the cloud server 1 to the browsing terminal 2B, 2C at the source of request. The format information is indicative of, for example, a file format, or an application program (e.g. Word®, PowerPoint®, Excel®, or a mailer program) in which the data is used. The request receiver 44 outputs the terminal information, user information, search key and format information to the feature amount extraction module 43, retrieval module 45 and converter 46.

The feature amount extraction module 43 extracts a first feature amount by analyzing the search key which has been output from the request receiver 44. To be more specific, the feature amount extraction module 43 calculates the first feature amount based on coordinates or time, by using the stroke data (time-series coordinate data sequence) in the search key. Similarly, by analyzing the handwritten document data 14A stored in the storage device 14, the feature amount extraction module 43 calculates feature amounts based on coordinates or time, with use of the stroke data included in the handwritten document data 14A. The feature amount extraction module 43 stores the calculated feature amounts of the handwritten document data 14A in the storage device 14 as feature amount data 14D. Then, the feature amount extraction module 43 outputs the calculated first feature amount of the search key to the retrieval module 45. In the meantime, the feature amount extraction module 43 calculates the feature amounts of the handwritten document data 14A, in response to the reception of the handwritten document data 14A from the handwriting terminal 2A, or in response to the reception of the search request from the browsing terminal 2B, 2C.

The retrieval module 45 searches the handwritten document data 14A stored in the storage device 14, by using the first feature amount of the search key which has been output from the feature amount extraction module 43. The retrieval module 45 retrieves handwritten document data having a second feature amount by using the feature amount data 14D corresponding to the handwritten document data 14A in the storage device 14, if the degree of similarity between the first feature amount of the search key and the second feature amount is equal to or greater than a threshold. Thereby, the retrieval module 45 retrieves, for example, candidates of handwritten document data based on the search key or a candidate of handwritten document data which is assumed to be most appropriate, for example, from the handwritten document data 14A in the storage device 14. The retrieval module 45 may retrieve candidates of handwritten document data, taking into account the number of times of browsing of each handwritten document data 14A, or the relationship between the create user of the handwritten document data 14A and the user of the requesting terminal 2B, 2C. The retrieval module 45 outputs the retrieved candidate (candidates) of the handwritten document data to the converter 46.

In addition, using the access right data 14C, the retrieval module 45 may determine whether the requesting terminal 2B, 2C (or the user of the requesting terminal 2B, 2C) is permitted to access each of the retrieved candidates of the handwritten document data. Specifically, the retrieval module 45 can extract, from the candidates of the handwritten document data, candidates which the requesting terminal 2B, 2C is permitted to access. In this case, the retrieval module 45 outputs to the converter 46 the candidates of the handwritten document data which have been extracted based on the access right.

In addition, for example, when the browsing terminal (requesting terminal) 2B, 2C does not include a touch-screen display, the search key in the search request from the browsing terminal 2B, 2C may include a search condition in which a character string (or a graphic, etc.) described in handwritten document data, a create user of handwritten document data, an access user, the time of creation, the time of access, etc., are designated. In this case, the retrieval module 45 retrieves handwritten document data which satisfies the search condition (and which is permitted to be accessed by the requesting terminal 2B, 2C), from the handwritten document data 14A in the storage device 14, and outputs the retrieved handwritten document data to the converter 46.

The converter 46 converts the handwritten document data, which has been output from the retrieval module 45, to a format which is requested by the requesting terminal 2B, 2C, or to a format which is suited to the requesting terminal 2B, 2C, and then outputs the converted data to the data transmitter 47.

For example, if the terminal information of the browsing terminal (requesting terminal) 2B, 2C indicates that the browsing terminal 2B, 2C does not have the handwritten document display function, the converter 46 converts the handwritten document data, which has been output from the retrieval module 45, to data of a format (e.g. image data) which can be displayed by the browsing terminal 2B, 2C. In the meantime, if the browsing terminal 2B, 2C has the handwritten document display function, the converter 46 outputs the handwritten document data, which has been output from the retrieval module 45, as such to the data transmitter 47.

In addition, based on the screen size of the browsing terminal 2B, 2C which is indicated in the terminal information, the converter 46 may convert the handwritten document data, which has been output from the retrieval module 45, to a display size corresponding to the screen size of the browsing terminal 2B, 2C.

The converter 46 can also generate new data by using the handwritten document data which has been output from the retrieval module 45. For example, the converter 46 recognizes a handwritten character, graphic, table, etc. described in the handwritten document, and converts the handwritten document data to a format which is available by other software (application program). The converter 46 converts the handwritten document data to, for example, a format which is designated in the format information.

To be more specific, the converter 46 recognizes a character from each of blocks (handwriting blocks), the blocks being obtained by executing a grouping process of a plurality of time-series stroke data in the handwritten document data that is the target of conversion. Thereby, the converter 46 converts the handwritten characters in the plural blocks to character codes. In the grouping process, the plural time-series stroke data are grouped so that stroke data corresponding to strokes, which are located close to each other and are handwritten continuously, is classified into the same block. The converter 46 holds in advance, for example, character information indicative of features of characters, and calculates the degree of similarity between a handwritten character and each of the plurality of characters. Then, the handwritten character is converted to a character code corresponding to a character having a highest degree of similarity to this handwritten character.

In addition, the converter 46 converts a process-target block of a plurality of blocks obtained by the above-described grouping process to one graphic object of a plurality of graphic objects. For example, a handwritten graphic in the handwritten document is converted to a graphic object which can be handled by an application program for presentation, such as PowerPoint. The converter 46 holds in advance, for example, graphic information indicative of features of a plurality of graphic objects, and calculates the degree of similarity between a handwritten graphic and each of the plurality of graphic objects. Then, the handwritten graphic is converted to a graphic object having a highest degree of similarity to this handwritten graphic.

In the calculation of the degree of similarity, the handwritten graphic may be rotated, scaled up or scaled down, where necessary. The degrees of similarity between the handwritten graphic, which has been rotated, scaled up or scaled down, and the plural graphic objects are calculated. Then, a graphic object having the highest degree of similarity to the handwritten graphic is selected from the plural graphic objects. The selected graphic object is transformed based on the processing of rotation, scaling up or scaling down, which has been executed on the handwritten graphic. This transformed graphic object is displayed in place of the handwritten graphic.

Various methods are usable as the method of calculating the degree of similarity between handwritten characters. For example, coordinate series of each stroke may be treated as a vector. In this case, in order to calculate the degree of similarity between vectors which are targets of comparison, an inner product between the vectors which are targets of comparison may be calculated as the degree of similarity between the vectors which are targets of comparison. In another example, the path of each stroke may be treated as an image, and the area of a part, where images of paths of targets of comparison overlap to a highest degree, may be calculated as the above-described degree of similarity. Furthermore, an arbitrary device may be made for reducing the amount of computation. Besides, dynamic programming (DP) matching may be used as the method of calculating the degree of similarity between handwritten characters. Thereby, a handwritten graphic can easily be converted to a paint-based document (application data) of, e.g. PowerPoint.

The converter 46 recognizes whether a process-target block of a plurality of blocks obtained by the above-described grouping process has a table shape including a combination of some line-shaped paths. When it is recognized that the process-target block has a table shape, the converter 46 converts the process-target block to a table object having the same numbers of vertical and horizontal elements as the numbers of vertical and horizontal elements of the recognized table shape.

A handwritten table in the handwritten document is converted to a table object which can be handled by a spreadsheet application program such as Excel. The converter 46 recognizes a combination of vertical and horizontal lines in the handwritten document, and recognizes that this combination constitutes a table. In the process of conversion to the table object, each handwritten element in the handwritten table may directly be input as handwritten data to the elements in the table object. Alternatively, a character code, which is obtained by character-recognizing each handwritten element in the handwritten table, may be input to the elements in the table object.

For example, by using pre-stored dictionary data, the converter 46 can also remove malicious information from the recognized characters, graphics or tables.

As regards the above-described various conversion processes, any one of these processes, or a plurality of processes combined properly, may be executed on the handwritten document data which has been output by the retrieval module 45.

The data transmitter 47 transmits the handwritten document data (or the data obtained by converting the handwritten document data to a predetermined format) output from the converter 46 to the requesting terminal (browsing terminal) 2B, 2C.

Next, the browsing terminal 2B, 2C is described.

The browsing terminal 2B, 2C executes a handwritten document browsing program 212B for downloading data from the cloud server 1 and browsing the downloaded data. The handwritten document browsing program 212B includes a request transmitter 31, a data receiver 32 and a display controller 33.

For example, in response to a request by the user, the request transmitter 31 transmits a delivery request for delivery of handwritten document data to the cloud server 1. As described above in connection with the cloud server 1, the delivery request includes terminal information relating to the browsing terminal 2B, 2C, user information relating to a user who uses the browsing terminal 2B, 2C, a search key for searching handwritten document data 14A, and format information indicative of the format of data which is to be delivered to the browsing terminal 2B, 2C. The terminal information includes, for example, information indicating whether or not the browsing terminal 2B, 2C has a function (handwritten document display function) of analyzing handwritten document data (stroke data) and displaying a handwritten document, and information indicative of the screen size of the browsing terminal 2B, 2C. The user information includes a user ID and a user name.

In addition, in the browsing terminal 2B, 2C including the handwriting input display, like the handwriting terminal 2A, a path of movement of an external object (pen or finger) on the screen of the handwriting input display is detected, and stroke data indicative of coordinate data series (time-series coordinates) corresponding to points on the detected path are generated. The request transmitter 31 can transmit the generated stroke data as a search key to the cloud server 1. Specifically, in the browsing terminal 2B, 2C including a handwriting input display, the user can input, with use of the handwriting input display, a handwritten character string, graphic, table, etc. as the search key for searching the handwritten document data 14A stored in the cloud server 1. On the other hand, in the browsing terminal 2B, 2C which is not provided with a handwriting input display, for example, a character string, which is input, for example, by using a keyboard, is set to be the search key.

The request transmitter 31 may further set, as the search key, a search condition in which a create user of handwritten document data, an access user, the time of creation, the time of access, etc., are designated.

In addition, the request transmitter 31 sets, as format information, a file format of data which is to be delivered from the cloud server 1, or an application program (e.g. Word, PowerPoint, Excel) which is executed by the browsing terminal 2B, 2C (i.e. an application program in which data is used).

The data receiver 32 receives (downloads) data which has been delivered from the cloud server 1 in response to the delivery request. The data receiver 32 outputs the received data to the display controller 33. The data receiver 32 may store the received data in a storage device 214.

The display controller 33 displays a handwritten document, etc. on the screen of the display 216 by using the data which has been output from the data receiver 32. To be more specific, when handwritten document data is being output from the data receiver 32 (i.e. when the browsing terminal 2B, 2C includes the handwritten document display function), the display controller 33 displays on the screen of the display 216 the paths corresponding to a plurality of stroke data in the handwritten document data. The browsing terminal 2B, 2C including the handwritten document display function is, for example, a terminal including a dedicated application program for handling handwritten document data.

In the meantime, in the browsing terminal 2B, 2C including the handwriting input display, the user can add a handwritten character string, graphic, table, etc. to the handwritten document displayed on the screen. When a handwritten character string, graphic, table, etc. are additionally input to the displayed document, the browsing terminal 2B, 2C, like the handwriting terminal 2A, detects a path of movement of an external object (pen or finger) on the screen of the handwriting input display, generates stroke data indicative of coordinate data series (time-series coordinates) corresponding to points on the detected path, and adds the stroke data to the original handwritten document data. The browsing terminal 2B, 2C transmits (uploads) the handwritten document data including the added stroke data to the cloud server 1. Thereby, the handwritten document data including the data added by the browsing terminal 2B, 2C can be stored in the cloud server 1.

In addition, when data which has been converted to a predetermined file format (i.e. converted data) is being output from the data receiver 32, the display controller 33 causes an application program, which is associated with this file format, to display the data. For example, when data which has been converted to an image of, e.g. JPEG is being output, the display controller 33 starts a predetermined application program which can display this image, and causes this application program to display on the screen the image corresponding to the output data. In addition, when data which has been converted to a file format of PowerPoint (e.g. PPT) is being output, the display controller 33 starts PowerPoint and causes PowerPoint to display on the screen a slide, etc. corresponding to the output data.

In the meantime, in the browsing terminal 2B, 2C including the handwriting input display, the user can additionally input a handwritten character string, graphic, table, etc. to the converted data (image, slide, etc.) displayed on the screen. When a handwritten character string, graphic, table, etc. are additionally input to the displayed converted data, the browsing terminal 2B, 2C, like the handwriting terminal 2A, detects a path of movement of an external object (pen or finger) on the screen of the handwriting input display, and generates handwritten document data including stroke data indicative of coordinate data series (time-series coordinates) corresponding to points on the detected path. This handwritten document data may include coordinate data series (stroke data) based on the coordinate system of an image, a slide, etc. displayed on the screen, or may include information indicative of the relationship between an image, a slide, etc. displayed on the screen, and the coordinate system. Then, the browsing terminal 2B, 2C associates the converted data of an image, a slide, etc. displayed on the screen (i.e. JPEG data or PowerPoint data) and the generated handwritten document data, and uploads the associated data to the cloud server 1.

The cloud server 1 stores the converted data and handwritten document data which are associated. Accordingly, another browsing terminal 2B, 2C can download a pair of converted data and handwritten document data from the cloud server 1, and can display these data by superimposing a handwritten document of the handwritten document data on an image or a slide of the converted data at the same position as the position at the time of generation (i.e. at the position intended by the user who performed handwriting).

In the meantime, the display controller 33 can also display related information of, e.g. the creator and the date of creation of the handwritten document data 14A on which the displayed data is based. By the display, the user can confirm the creator and the date of creation of the displayed document (or image, slide, etc.).

By the above-described structure, the cloud server 1 can provide handwritten document data, without depending on the function possessed by the browsing terminal 2B, 2C. The cloud server 1 stores the handwritten document data, which has been transmitted from the handwriting terminal 2A, in the storage 14 in the cloud server 1. Then, responding to a request from the browsing terminal 2B, 2C, the cloud server 1 transmits handwritten document data, among the plural handwritten document data 14A stored in the storage, to the browsing terminal 2B, 2C via the network. Thereby, a certain user can not only browse (retrieve) the handwritten document created by the user himself/herself, but also can make other users to browse his/her own created handwritten document or can browse handwritten document created by other users. Moreover, by using the access right data 14C, the permission/inhibition of browsing can be controlled according to users (e.g. according to an acquaintance or a stranger).

As has been described above, since the handwritten document data generated by the handwriting terminal 2A is managed in the cloud server 1 and is provided to the browsing terminal 2B, 2C, the local processing load on each terminal 2A, 2B, 2C can be reduced.

FIG. 8 shows an example of data to which handwritten document data 14A has been converted by the cloud server 1. It is assumed that the handwritten document data 14A corresponding to the handwritten document 51 shown in FIG. 3 is converted to data of a slide 52 which is a presentation material used by presentation software.

The converter 46 of the cloud server 1, as described above, recognizes handwritten characters, symbols, graphics, tables, etc. in the handwritten document 51, by using time-series stroke data in the handwritten document data 14A. Then, the converter 46 converts handwritten characters, handwritten graphics and handwritten tables to character codes, graphic objects and table objects, respectively, and to data of the slide 52 used by presentation software.

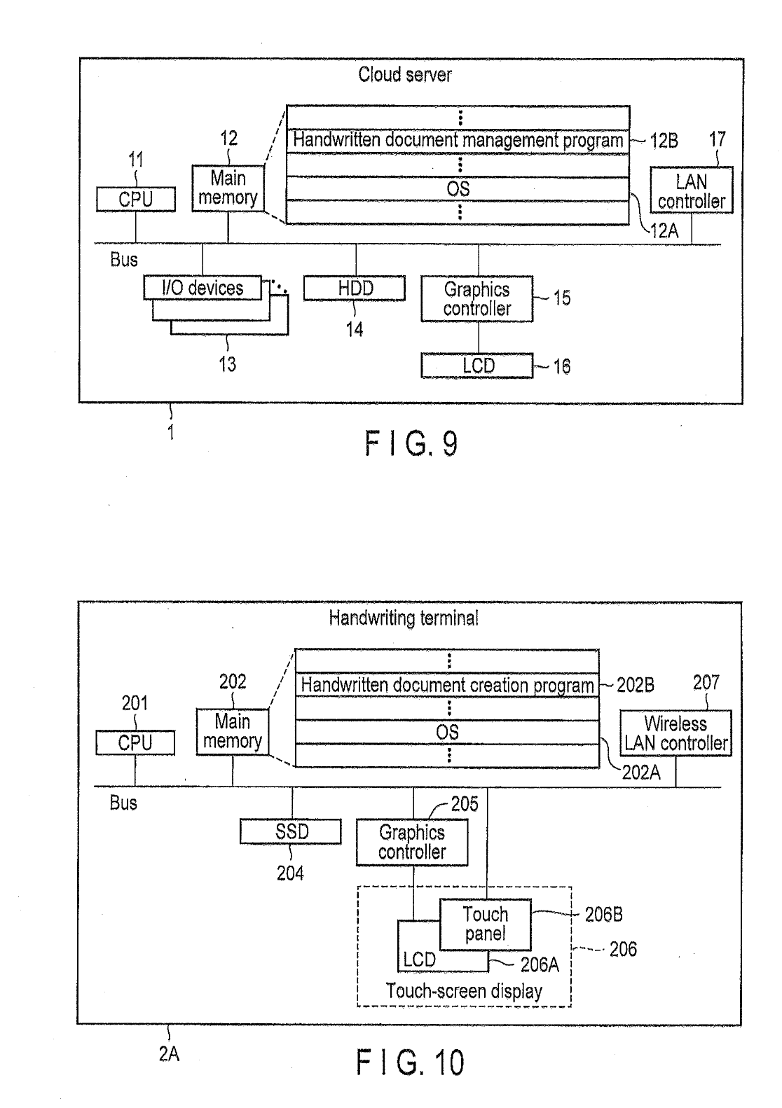

Next, FIG. 9 illustrates an example of the system configuration of the cloud server 1. The cloud server 1 includes a central processing unit (CPU) 11, a main memory 12, I/O devices 13, a hard disk drive (HDD) 14, a graphics controller 15, a liquid crystal display (LCD) 16, and a LAN controller 17.

The CPU 11 is a processor which executes various programs. The CPU 11 executes various computing processes and controls the respective components in the cloud server 1.

The main memory 12 is a memory for storing an operating system (OS) 12A and various applications programs such as handwritten document management program 12B, which are executed by the CPU 11, and also storing various data. For example, the OS 12A and handwritten document management program 12B are loaded in the main memory 12.

The I/O devices 13 are various input/output devices for executing data input/output from/to the cloud server 1. The HDD 14 is a nonvolatile storage device for storing various programs and data. The various programs and data stored in the HDD 14 are loaded in the main memory 12 in response to requests by the respective components in the cloud server 1. The operation of the handwritten document management program 12B, which is loaded in the main memory 12, is as has been described with reference to FIG. 5, etc.

The graphics controller 15 controls the LCD 16 which is used as a display monitor of the cloud server 1. A display signal, which is generated by the graphics controller 15, is sent to the LCD 16. By using the graphics controller 15 and LCD 16, for example, a screen corresponding to an operation by an administrator can be displayed.

The LAN controller 17 is a wired communication device which executes wired communication of, e.g. Ethernet™ standards.

FIG. 10 illustrates an example of the system configuration of the handwriting terminal (first electronic device) 2A. The handwriting terminal 2A includes a central processing unit (CPU) 201, a main memory 202, a solid-state drive (SSD) 204, a graphics controller 205, a touch-screen display 206, and a wireless LAN controller 207.

The CPU 201 is a processor which executes various programs. The CPU 201 executes various computing processes and controls the respective components in the handwriting terminal 2A.

The main memory 202 is a memory for storing an operating system (OS) 202A and various applications programs such as handwritten document creation program 202B, which are executed by the CPU 201, and also storing various data. For example, the OS 202A and handwritten document creation program 202B are loaded in the main memory 202.

The SSD 204 is a nonvolatile storage device for storing various programs and data. The various programs and data stored in the SSD 204 are loaded in the main memory 202 in response to requests by the respective components in the handwriting terminal 2A. The operation of the handwritten document creation program 202B, which is loaded in the main memory 202, is as has been described with reference to FIG. 5, etc.

The graphics controller 205 generates a display signal which is to be displayed on the touch-screen display 206. A flat-panel display 206A and a sensor, which is configured to detect a contact position of a pen or a finger on the screen of the flat-panel display 206A, are assembled in the touch-screen display 206. The flat-panel display 206A may be, for example, a liquid crystal display (LCD). As the sensor, for example, use may be made of a capacitance-type touch panel 206B, or an electromagnetic induction-type digitizer.

The wireless LAN controller 207 is configured to execute wireless communication based on e.g. IEEE 802.11 standards.

FIG. 11 illustrates an example of the system configuration of the browsing terminal (second electronic device) 2B, 2C. The browsing terminal 2B, 2C includes a central processing unit (CPU) 211, a main memory 212, a solid-state drive (SSD) 214, a graphics controller 215, a liquid crystal display (LCD) 216, and a wireless LAN controller 217.

The CPU 211 is a processor which executes various programs. The CPU 211 executes various computing processes and controls the respective components in the browsing terminal 2B, 2C.

The main memory 212 is a memory for storing an operating system (OS) 212A and various applications programs such as handwritten document browsing program 212B, which are executed by the CPU 211, and also storing various data. For example, the OS 212A and handwritten document browsing program 212B are loaded in the main memory 212.

The SSD 214 is a nonvolatile storage device for storing various programs and data. The various programs and data stored in the SSD 214 are loaded in the main memory 212 in response to requests by the respective components in the browsing terminal 2B, 2C. The operation of the handwritten document browsing program 212B, which is loaded in the main memory 212, is as has been described with reference to FIG. 5, etc.

The graphics controller 215 controls the LCD 216 which is used as a display monitor of the browsing terminal 2B, 2C. A display signal, which is generated by the graphics controller 215, is sent to the LCD 216. By using the graphics controller 215 and LCD 216, for example, a handwritten document, an image, a slide, etc., which have been received from the cloud server 1, can be displayed. In the meantime, the browsing terminal 2B, 2C may include a touch-screen display which is similar to the touch-screen display 206 in the handwriting terminal 2A.

The wireless LAN controller 217 is configured to execute wireless communication based on e.g. IEEE 802.11 standards.

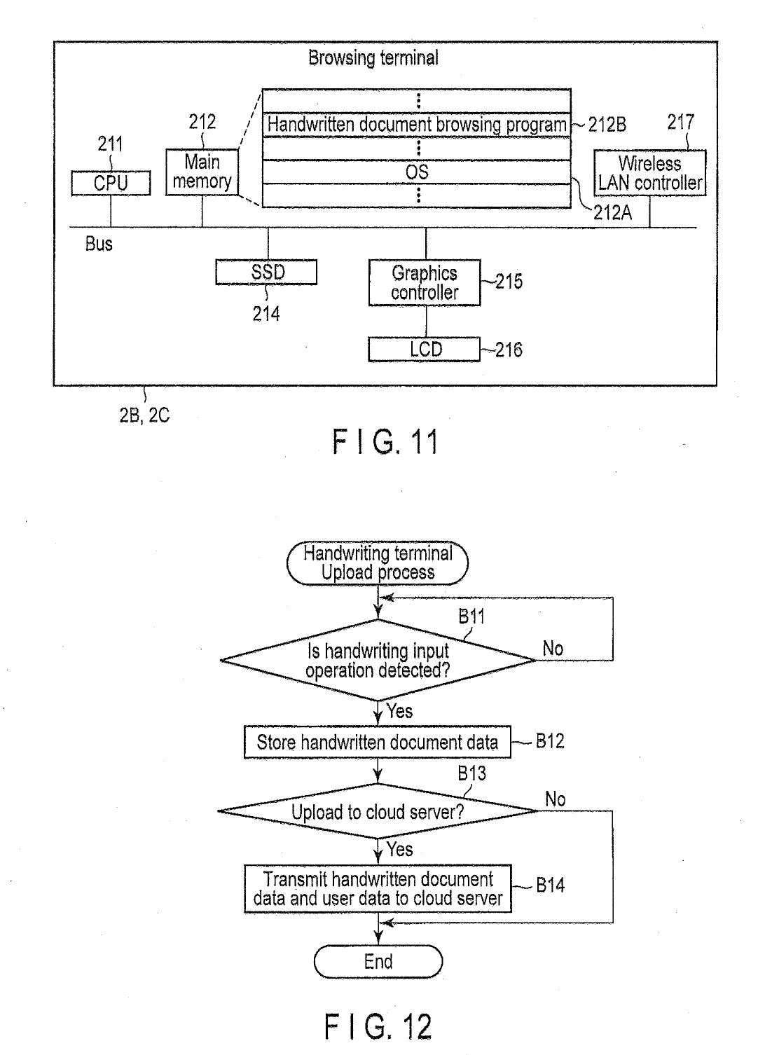

Next, referring to a flowchart of FIG. 12, a description is given of an example of the procedure of an upload process which is executed by the handwriting terminal 2A.

To start with, the handwriting information detector 22 determines whether a handwriting input operation using the handwriting input display (touch-screen display) 206 has been detected (block B11). When a handwriting input operation has not been detected (NO in block B11), the process returns to block B11, it is determined once again whether a handwriting input operation has been detected.

When a handwriting input operation has been detected (YES in block B11), the handwriting information processor 23 generates handwritten document data 204A including stroke data corresponding to a path which has been input by the detected handwriting input operation, and stores the generated handwritten document data 204A in the storage device 204 (block B12). The handwriting information transmitter 24 determines whether the generated handwritten document data 204A is to be uploaded to the cloud server 1 (block B13). For example, when an operation of requesting upload of the handwritten document data 204A has been performed by the user, or when the handwritten document data 204A has been stored in a predetermined area (e.g. predetermined directory) in the storage device 204, the handwriting information transmitter 24 determines that the generated handwritten document data 204A is to be uploaded to the cloud server 1.

When the handwritten document data 204A is to be uploaded to the cloud server 1 (YES in block B13), the handwriting information transmitter 24 transmits the handwritten document data 204A and user data 204B to the cloud server 1 (block B14). The user data 204B includes, for example, information indicative of the user who performed the handwriting input operation (e.g. user name, user ID). The handwriting information transmitter 24 may further transmit access right data for setting an access right to the handwritten document data 204A to the cloud server 1.

By the above-described process, in response to the handwriting input operation using the handwriting input display 206 provided in the handwriting terminal 2A, the handwritten document data 204A is generated, and uploaded to the cloud server 1.

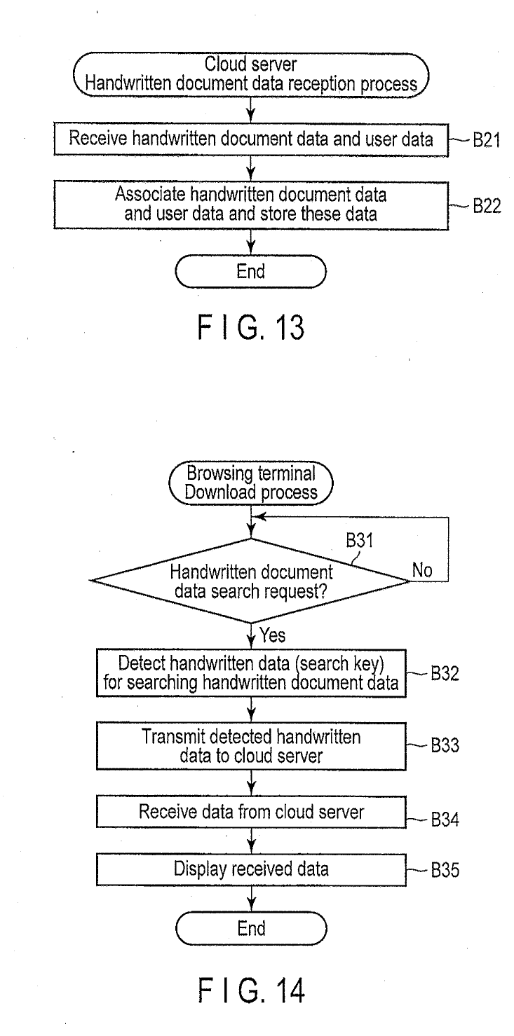

FIG. 13 is a flowchart illustrating an example of the procedure of a handwritten document data reception process which is executed by the cloud server 1.

To start with, the handwriting information receiver 41 receives the handwritten document data 204A and user data 204B, which have been transmitted from the handwriting terminal 2A (block B21). Then, the handwriting information storage module 42 associates the handwritten document data 204A with the user data 204B and stores these data in the storage device 14 (block B22). To be more specific, the handwriting information storage module 42 adds the received handwritten document data 204A to the handwritten document data 14A stored in the storage device 14. The handwriting information storage module 42 adds an entry corresponding to the received user data 204B to the user data 14B stored in the storage device 14. In addition, the handwriting information storage module 42 may set an access right to the stored (added) handwritten document data 204A, by adding an entry corresponding to the access right data, which has been output from the handwriting terminal 2A, to the access right data 14C stored in the storage device 14.

By the above process, the handwritten document data 204A, which has been transmitted from the handwriting terminal 2A, can be stored in the storage device 14 in the cloud server 1.

FIG. 14 is a flowchart illustrating an example of the procedure of a download process which is executed by the browsing terminal 2B, 2C. In the description below, it is assumed that a search request, in which handwritten data is set as a search key, is transmitted from the browsing terminal 2B, 2C to the cloud server 1.

To start with, the request transmitter 31 determines whether there is a search request for handwritten document data to the cloud server 1 (block B31). When there is no search request for handwritten document data (NO in block B31), the process returns to block B31, and it is determined once again whether there is a search request for handwritten document data.

When there is a search request for handwritten document data to the cloud server 1 (YES in block B31), the request transmitter 31 detects handwritten data which is used as a search key for searching the handwritten document data 14A (block B32). The handwritten data includes stroke data corresponding to the path input by the handwriting input operation. The request transmitter 31 transmits the detected handwritten data (search key) to the cloud server 1 (block B33).

Subsequently, the data receiver 32 receives, from the cloud server 1, handwritten document data 214A which relates to the transmitted handwritten data (search key) (block B34). The data receiver 32 stores the received handwritten document data 214A in the storage device 214. Using the received handwritten document data 214A, the display controller 33 displays a handwritten document on the display 216 (block B35).

By the above process, the user can browse the handwritten document data 214A corresponding to the search key, which has been downloaded from the cloud server 1. The data, which is downloaded from the cloud server 1, is not limited to the handwritten document data, and may be data (e.g. an image, a slide) which has been converted to a format suitable for the browsing terminal 2B, 2C.

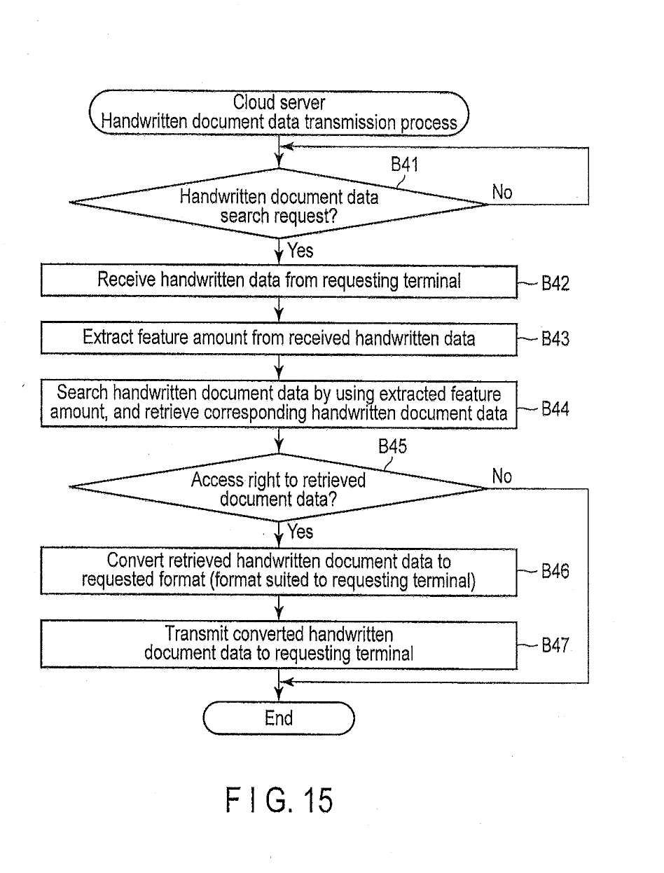

Next, referring to a flowchart of FIG. 15, a description is given of an example of the procedure of a handwritten document data transmission process which is executed by the cloud server 1. In the description below, like FIG. 14, it is assumed that a search request, in which handwritten data is set as a search key, is transmitted from the browsing terminal 2B, 2C to the cloud server 1.

To start with, the request receiver 44 determines whether a search request for handwritten document data has been received from the browsing terminal 2B, 2C (block B41). When a search request for handwritten document data has not been received (NO in block B41), the process returns to block B41, and it is determined once again whether a search request for handwritten document data has been received.

When a search request for handwritten document data has been received (YES in block B41), the request receiver 44 receives handwritten data of the search key from the browsing terminal (i.e. requesting terminal) 2B, 2C (block B42). The feature amount extraction module 43 extracts a first feature amount by analyzing the received handwritten data (search key) (block B43). Then, the retrieval module 45 retrieves handwritten document data corresponding to the first feature amount, by searching the handwritten document data 14A in the storage device 14 with use of the extracted first feature amount (block B44). The retrieval module 45 retrieves handwritten document data having a second feature amount, if the degree of similarity between the second feature amount and the first feature amount of the search key is equal to or greater than a threshold.

Subsequently, using the access right data 14C, the retrieval module 45 determines whether the requesting browsing terminal 2B, 2C is permitted to access the retrieved handwritten document data (block B45). When the access to the retrieved handwritten document data is inhibited (NO in block B45), the process is terminated. In the meantime, the retrieval module 45 may return to block B44, and may retrieve other handwritten document data, the access to which is permitted.

When the access to the retrieved handwritten document data is permitted (YES in block B45), the converter 46 converts the retrieved handwritten document data to, e.g. a format which is requested by the requesting terminal 2B, 2C, or a format which is suitable for the requesting terminal 2B, 2C (block B46). Specifically, the converter 46 converts the retrieved handwritten document data, for example, according to whether the requesting terminal 2B, 2C has the function of displaying handwritten document data (i.e. the function of displaying, with use of stroke data in handwritten document data, a handwritten document in which a corresponding path is drawn). If the requesting terminal 2B, 2C does not have the function of displaying handwritten document data, the converter 46 converts the handwritten document data to image data in which paths corresponding to the stroke data in the handwritten document data are drawn. In addition, the converter 46 recognizes an object such as a character, a symbol or a table, for example, by analyzing the paths corresponding to the stroke data in the handwritten document data, and converts the handwritten document data to a format which is used in word-processing software, presentation software or a conception supporting tool.

Then, the data transmitter 47 transmits the converted handwritten document data to the requesting terminal 2B, 2C (block B47).

By the above process, the cloud server 1 can transmit handwritten document data to the browsing terminal 2B, 2C, in response to a request from the browsing terminal 2B, 2C.

As has been described above, according to the present embodiment, handwritten document data can be provided in accordance with an electronic device that is a delivery target. The cloud server 1 stores the handwritten document data, which has been transmitted from the handwriting terminal 2A, in the storage 14 in the cloud server 1. Then, in response to a request by the browsing terminal 2B, 2C, the cloud server 1 transmits handwritten document data, among the plural handwritten document data 14A stored in the storage, to the browsing terminal 2B, 2C. Thereby, the cloud server 1 can provide handwritten document data, for example, without depending on the function possessed by the browsing terminal 2B, 2C.

All the process procedures in this embodiment, which have been described with reference to the flowcharts of FIGS. 12 to 15, can be executed by software. Thus, the same advantageous effects as with the present embodiment can easily be obtained simply by installing a computer program, which executes the process procedures, into an ordinary computer through a computer-readable storage medium which stores the computer program, and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A system which is connectable to a plurality of electronic devices via a network, the apparatus comprising:
a receiver configured to receive handwritten document data from a first electronic device, wherein the handwritten document data comprises a plurality of stroke data corresponding to a plurality of strokes;
a storage configured to store a received handwritten document data in addition to a plurality of handwritten document data;
a retrieval module configured to retrieve, in response to a request by a second electronic device, first handwritten document data from the plurality of handwritten document data in the storage, the first handwritten document data corresponding to the request; and
a transmitter configured to transmit the first handwritten document data to the second electronic device.

2. The system of claim 1, further comprising a converter configured to convert a format of the first handwritten document data to a format which can be compatible with the second electronic device,
wherein the transmitter is configured to transmit a converted first handwritten document data to the second electronic device.

3. The system of claim 2, wherein the converter is configured to convert the first handwritten document data to image data.

4. The system of claim 2, wherein the converter is configured to convert the first handwritten document data to a file format used in an application program executable by the second electronic device.

5. The system of claim 2, wherein the converter is configured to convert the first handwritten document data in accordance with a size of a display in the second electronic device.

6. The system of claim 1, wherein each of the plurality of stroke data comprises coordinate data series corresponding to points on an associated stroke, and
the handwritten document data comprises the plurality of stroke data, an order of handwriting of the plurality of stroke data being identifiable in the handwritten document data.

7. The system of claim 6, wherein the request by the second electronic device comprises a search key comprising one or more stroke data, an order of handwriting of the one or more stroke data being identifiable in the handwritten document data, and
the retrieval module is configured to retrieve the first handwritten document data based on the search key.

8. The system of claim 7, wherein the retrieval module is configured to calculate a first feature amount by using the one or more stroke data in the search key, and to retrieve the first handwritten document data having a second feature amount, and wherein a degree of similarity between the first feature amount and the second feature amount is equal to or greater than a threshold.

9. The system of claim 1, wherein the retrieval module is further configured to determine whether the second electronic device is permitted to browse the first handwritten document data, and
the transmitter is configured to transmit the first handwritten document data to the second electronic device if the second electronic device is permitted to browse the first handwritten document data.

10. A handwritten document management method of managing a handwritten document by a system which is connectable to a plurality of electronic devices via a network, the method comprising:
receiving handwritten document data from a first electronic device, wherein the handwritten document data comprises a plurality of stroke data corresponding to a plurality of strokes;
storing a received handwritten document data in addition to a plurality of handwritten document data;
retrieving, in response to a request by a second electronic device, first handwritten document data from the plurality of handwritten document data in the storage, the first handwritten document data corresponding to the request; and
transmitting the first handwritten document data to the second electronic device.

11. A computer-readable storage medium having stored thereon a program which is executable by a computer which is connectable to a plurality of electronic devices via a network, the program controlling the computer to execute functions of:
receiving handwritten document data from a first electronic device, wherein the handwritten document data comprises a plurality of stroke data corresponding to a plurality of strokes;
storing a received handwritten document data in addition to a plurality of handwritten document data;
retrieving, in response to a request by a second electronic device, first handwritten document data from the plurality of handwritten document data in the storage, the first handwritten document data corresponding to the request; and
transmitting the first handwritten document data to the second electronic device.
